(19) United States
(12) Patent Application Publication
(10) Pub. No.: US 2020/0412104 A1
(43) Pub. Date: Dec. 31, 2020

(54) SPARK PLUG

(71) Applicant: NGK Spark Plug Co., Ltd., Nagoya-shi, Aichi (JP)

(72) Inventor: Koichiro SAITO, Nagoya-shi, Aichi (JP)

(73) Assignee: NGK Spark Plug Co., Ltd., Nagoya-shi, Aichi (JP)

(21) Appl. No.: 16/971,596

(22) PCT Filed: Jan. 18, 2019
(86) PCT No.: PCT/JP2019/001448

§ 371 Date: Aug. 20, 2020

(30) Foreign Application Priority Data
May 23, 2018 (JP) 2018-099042

(51) Int. Cl. H01T 13/16; H01T 13/36

(52) U.S. Cl. CPC H01T 13/16; H01T 13/36

(57) ABSTRACT

A spark plug including a tubular insulator extending in the direction of an axial line from a forward end side to a rear end side; and a tubular metallic shell fixed to an outer circumference of the insulator, the tubular metallic shell having a male thread formed on part of an outer circumferential surface thereof. The insulator has a groove formed in a region of an outer circumference thereof, the region overlapping the male thread of the metallic shell in the direction of the axial line. At least part of a heat transfer member is disposed in the groove. In a cross section passing through the axial line and extending along the axial line, the depth of the groove decreases toward at least one of a forward opening end of the groove and a rear opening end thereof.

### FIELD OF THE INVENTION

The present invention relates to spark plugs and, more particularly, to a spark plug in which a heat transfer member is fixed to the outer circumference of an insulator.

### BACKGROUND OF THE INVENTION

A known spark plug includes a tubular metallic shell having a male thread to be joined to an internal combustion engine and an insulator held by the metallic shell. US 2011/0227472 (“PTL 1”) discloses a spark plug including a metallic sleeve (heat transfer member) brazed to the outer circumferential surface of an insulator. In the spark plug in PTL 1, part of the heat of the insulator heated by combustion gas transfers to the sleeve by heat conduction and then transfers from the sleeve to the metallic shell.

### Technical Problem

However, the above conventional technique requires control of various parameters such as the wettability and reactivity between the insulator and the brazing material used to join the sleeve (heat transfer member) to the insulator and stress generated in the insulator because of the difference in linear expansion coefficient between the sleeve and the insulator, and the control of the parameters is complicated.

### SUMMARY OF THE INVENTION

The present invention has been made to solve the foregoing problem, and it is an object to provide a spark plug in which heat transfer from the insulator to the metallic shell is ensured and in which the heat transfer member can be easily fixed to the insulator.

### Solution

In order to achieve this object, a spark plug of the present invention comprises a tubular insulator extending in the direction of an axial line from a forward end side to a rear end side, and a tubular metallic shell fixed to an outer circumference of the insulator, the tubular metallic shell having a male thread formed on a part of an outer circumferential surface thereof. The insulator has a groove formed in a region of the outer circumference of the insulator, the region overlapping the male thread of the metallic shell in the direction of the axial line, and at least a part of a heat transfer member is disposed in the groove. In a cross section passing through the axial line and extending along the axial line, the depth of the groove decreases toward at least one of a forward opening end of the groove and a rear opening end thereof.

### Advantageous Effects of Invention

In the spark plug according to a first aspect of the present invention, since at least part of the heat transfer member is disposed in the groove formed on the outer circumferential surface of the insulator, the heat transfer member can be easily fixed to the insulator. Moreover, the depth of the groove decreases toward at least one of the forward opening end and the rearward opening end. Therefore, when the axial length of the insulator relative to the metallic shell changes due to heat or the pressure inside a combustion chamber changes due to, for example, intake or exhaust of gas, and the wall surface of the groove of the insulator comes into contact with the heat transfer member, the heat transfer member can apply a radially inward reaction force to the insulator. This allows the heat transfer member and the insulator to easily come into intimate contact with each other, so that part of the heat of the insulator can easily transfer to the heat transfer member by heat conduction and can then transfer from the heat transfer member to the metallic shell. Therefore, heat transfer from the insulator to the metallic shell can be ensured.

In the spark plug according to a second aspect of the present invention, a forward-facing surface of the groove of the insulator is inclined such that the depth of the forward-facing surface changes toward the rear end side as approaching the opening end of the groove at the rear end side, or a rearward-facing surface of the groove of the insulator is inclined such that the depth of the rearward-facing surface changes toward the forward end side as approaching the opening end of the groove at the forward end side. As a result, stress generated at a corner of the groove when a bending load is applied to the insulator can be relaxed. Therefore, in addition to the effect achieved by the spark plug according to the first aspect of the present invention, breakage of the insulator starting from the groove can be prevented.

In the spark plug according to a third aspect of the present invention, since a rear end surface of the heat transfer member is inclined along the forward-facing surface, or a forward end surface of the heat transfer member is inclined along the rearward-facing surface, the area of contact between the heat transfer member and the forward-facing surface or the rearward-facing surface of the groove can be increased. Therefore, in addition to the effect achieved by the spark plug according to the second aspect of the present invention, the heat of the insulator can more easily transfer to the heat transfer member by heat conduction.

In the spark plug according to a fourth aspect of the present invention, since the heat transfer member is in contact with a part of an inner circumferential surface of the metallic shell, in addition to the effect achieved by the spark plug according to the first through third aspects, the heat of the heat transfer member can transfer to the metallic shell by heat conduction.

In the spark plug according to a fifth aspect of the present invention, since the heat transfer member has a ring shape having a cutout, in addition to the effect achieved by the spark plug according to the first through fourth aspects, the area of contact between the metallic shell and the heat transfer member can be increased by elastically deforming the heat transfer member in the radial direction of the ring, so that the heat of the heat transfer member can easily transfer to the metallic shell by heat conduction.

In the spark plug according to a sixth aspect of the present invention, since a length of the heat transfer member in the direction of the axial line is longer than a length of the heat transfer member in a direction orthogonal to the axial line, the depth of the groove into which the heat transfer member is fitted can be reduced. Therefore, in addition to the effects of the spark plug according to the first through fifth aspect of the present invention, the mechanical strength of the groove of the insulator can be ensured.

### BRIEF DESCRIPTION OF DRAWINGS

FIG. 1 is a half sectional view of a spark plug in a first embodiment.

FIG. 2. is a perspective view of a heat transfer member.

FIG. 3 is a partial enlarged view of a portion indicated by III in FIG. 1.

FIG. 4 is a partial enlarged view of a spark plug in a second embodiment.

FIG. 5. is a partial enlarged view of a spark plug in a third embodiment.

FIG. 6. is a partial enlarged view of a spark plug in a fourth embodiment.

### DETAILED DESCRIPTION OF THE INVENTION

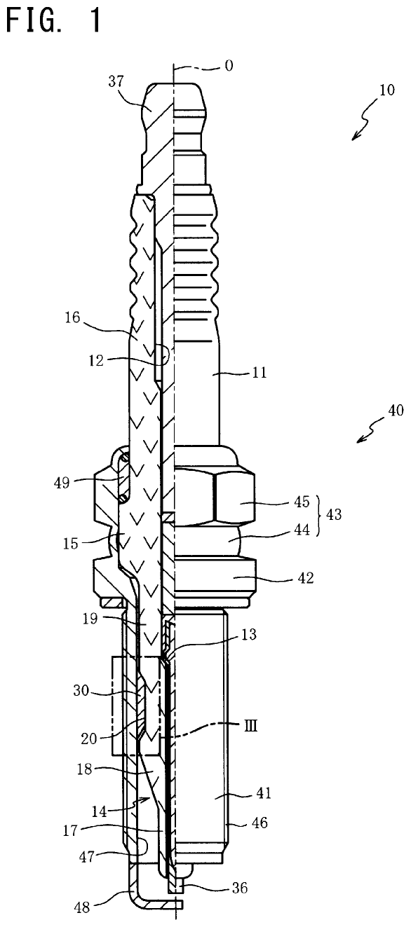

Preferred embodiments of the present invention will be described with reference to the accompanying drawings. FIG. 1 is a half sectional view of a spark plug 10 in a first embodiment, which is sectioned on one side of an axial line O. In FIG. 1, the lower side in the drawing sheet is referred to as a forward end side of the spark plug 10, and the upper side in the drawing sheet is referred to as a rear end side of the spark plug 10 (the same applies to other figures). As shown in FIG. 1, the spark plug 10 includes an insulator 11 and a metallic shell 40.

The insulator 11 is an approximately cylindrical member formed of, for example, alumina excellent in insulating and mechanical properties at high temperature. The insulator 11 has an axial hole 12 passing therethrough along the axial line O. A reducing diameter portion 13 whose diameter is reduced toward the forward end side is formed in a forward end portion of the axial hole 12. The insulator 11 has a forward end portion 14, a protruding portion 15, and a rear end portion 16, which are successively arranged along the axial line O in this order from the forward end side. The protruding portion 15 has a maximum outer diameter portion of the insulator 11.

The forward end portion 14 located adjacent to and forward of the protruding portion 15 is a portion of the insulator 11 that is disposed inside a trunk portion 41 (described later) of the metallic shell 40. The forward end portion 14 has a first portion 17, a second portion 18, and a third portion 19 that are arranged from the forward end side toward the rear end side so as to be adjacent to one another. The first portion 17 is a cylindrical portion whose outer diameter is substantially constant over the entire length of the first portion 17 in the direction of the axial line O. The second portion 18 is a truncated conical portion whose outer diameter increases toward the rear end side. The third portion 19 is a cylindrical portion whose outer diameter is substantially constant over the entire length of the third portion 19 in the direction of the axial line O. The outer diameter of the third portion 19 is larger than the outer diameter of the first portion 17. A groove 20 recessed radially inward is formed in the third portion 19. In the present embodiment, the groove 20 is formed over the entire circumference of the third portion 19. A heat transfer member 30 is fitted into the groove 20.

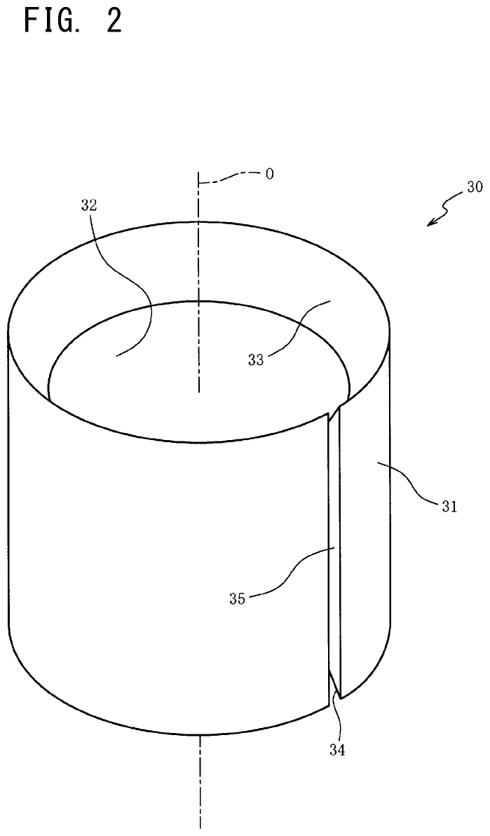

FIG. 2 is a perspective view of the heat transfer member 30. The heat transfer member 30 is a cylindrical member having an outer circumferential surface 31 and an inner circumferential surface 32 and is formed of a metal material (including stainless steel) excellent in thermal conductivity and oxidation resistance. The heat transfer member 30 has a slit 35 which is formed by partially cutting the ring-shaped heat transfer member 30 and extends straight along the axial line O.

In the present embodiment, the axial length of the outer circumferential surface 31 of the heat transfer member 30 is longer than the axial length of the inner circumferential surface 32 of the heat transfer member 30. A rear end surface 33 that connects the outer circumferential surface 31 to the inner circumferential surface 32 is inclined such that its depth changes toward the forward end side (the lower side in FIG. 2) as extending toward the radially inner side. A forward end surface 34 that connects the outer circumferential surface 31 to the inner circumferential surface 32 is inclined such that its depth changes toward the rear end side (the upper side in FIG. 2) as extending toward the radially inner side.

Returning to FIG. 1, the description will be continued. A center electrode 36 is a rod-shaped electrode inserted into the forward end side of the axial hole 12 and held by the insulator 11 to extend along the axial line O. The center electrode 36 is engaged with the reducing diameter portion 13 of the insulator 11, and the forward end of the center electrode 36 protrudes from the insulator 11. The center electrode 36 is configured such that a core excellent in thermal conductivity is embedded in an electrode base metal. The electrode base metal is formed of a metal material made of Ni or an alloy whose main component is Ni, and the core is formed of copper or an alloy whose main component is copper. The core may be omitted.

A metallic terminal 37 is a rod-shaped member to which a high-voltage cable (not shown) is to be connected and is formed of an electrically conductive metal material (such as low-carbon steel). The metallic terminal 37 is electrically connected to the center electrode 36 within the axial hole 12.

The metallic shell 40 is an approximately cylindrical member formed of an electrically conductive metal material (such as low-carbon steel). The metallic shell 40 has the trunk portion 41 surrounding the forward end portion 14 of the insulator 11, a seat portion 42 located on the rear end side of the trunk portion 41 and connected to the trunk portion 41, and a rear end portion 43 located on the side of the seat portion 42 opposite the trunk portion 41 and connected to the seat portion 42. The rear end portion 43 has a thin-walled portion 44 having a smaller wall thickness than the seat portion 42 and a tool engagement portion 45 protruding radially outward than the thin-walled portion 44.

The trunk portion 41 has a male thread 46 formed on its outer circumferential surface. The male thread 46 is screwed into a screw hole of an internal combustion engine (not shown). The male thread 46 engages with the screw hole of the internal combustion engine (not shown) to fix the metallic shell 40 to the internal combustion engine. In a section obtained by cutting the trunk portion 41 along a plane perpendicular to the axial line O, the inner circumferential surface 47 of the trunk portion 41 has a circular shape having a center coinciding with the axial line O. The inner diameter of the trunk portion 41 is set to be constant over the entire axial length of the trunk portion 41. The outer diameter of the heat transfer member 30 (see FIG. 2) when no load is applied thereto at room temperature (15 to 25° C.) is substantially the same as the inner diameter of the trunk portion 41.

The seat portion 42 is a portion for limiting the screwing amount of the male thread 46 into the internal combustion engine and closing the gap between the male thread 46 and the screw hole. The thin-walled portion 44 is a portion plastically deformed and crimped when the metallic shell 40 is attached to the insulator 11. The tool engagement portion 45 is a portion for engagement with a tool such as a wrench when the male thread 46 is screwed into the screw hole of the internal combustion engine.

A ground electrode 48 is a rod-shaped metallic (e.g., nickel-based alloy-made) member joined to the trunk portion 41 of the metallic shell 40. A spark gap is formed between the ground electrode 48 and the center electrode 36. In the present embodiment, the ground electrode 48 is bent. A seal member 49 formed of charged talc, etc. is disposed radially inward of the thin-walled portion 44 and the tool engagement portion 45 of the metallic shell 40 and rearward of the protruding portion 15 of the insulator 11. The seal member 49 provides gastight sealing between the insulator 11 and the metallic shell 40.

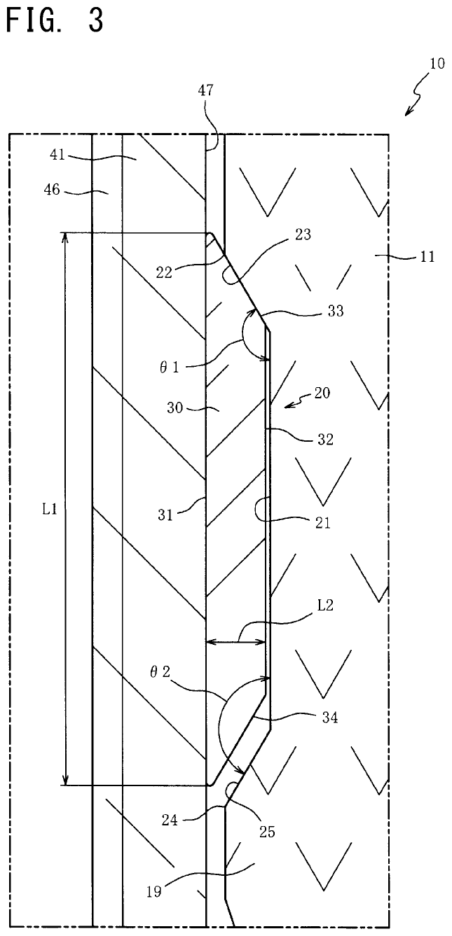

FIG. 3 is a partial enlarged view of a portion indicated by III in FIG. 1 (the cross-sectional view including the axial line O). In the cross section of the spark plug 10 including the axial line O, a groove bottom 21 of the groove 20 is approximately parallel to the axial line O (see FIG. 1). The depth of the groove 20 decreases gradually from the rear end of the groove bottom 21 toward a rear opening end 22 and decreases gradually from the forward end of the groove bottom 21 toward a forward opening end 24.

A forward-facing surface 23 of the groove 20 that is adjacent to the rear end of the groove bottom 21 is a conical surface inclined such that its depth changes toward the rear end side as approaching the rear opening end 22, and a rearward-facing surface 25 of the groove 20 that is adjacent to the forward end of the groove bottom 21 is a conical surface inclined such that its depth changes toward the forward end side as approaching the forward opening end 24. In the cross section including the axial line O, the angle θ1 between the groove bottom 21 and the forward-facing surface 23 is larger than 90°, and the angle θ2 between the groove bottom 21 and the rearward-facing surface 25 is larger than 90°. θ1 and θ2 are smaller than 180°.

The axial length of the inner circumferential surface 32 of the heat transfer member 30 is shorter than the axial length of the groove bottom 21 of the groove 20. The rear end surface 33 of the heat transfer member 30 is a conical surface inclined along the forward-facing surface 23 of the groove 20. The forward end surface 34 of the heat transfer member 30 is a conical surface inclined along the rearward-facing surface 25 of the groove 20. Therefore, when the rear end surface 33 of the heat transfer member 30 comes into contact with the forward-facing surface 23 of the groove 20, a gap is formed between the forward end surface 34 of the heat transfer member 30 and the rearward-facing surface 25 of the groove 20. Similarly, when the forward end surface 34 of the heat transfer member 30 comes into contact with the rearward-facing surface 25 of the groove 20, a gap is formed between the rear end surface 33 of the heat transfer member 30 and the forward-facing surface 23 of the groove 20.

The maximum axial length L1 of the heat transfer member 30 (in the present embodiment, the length of the outer circumferential surface 31) is longer than its length L2 in a direction orthogonal to the axial line O (see FIG. 1). Similarly, the axial length of the inner circumferential surface 32 of the heat transfer member 30 is longer than the length L2. In the present embodiment, the outer circumferential surface 31 of the heat transfer member 30 is in contact with the inner circumferential surface 47 of the trunk portion 41. A gap is present between the third portion 19 of the insulator 11 and the inner circumferential surface 47 of the trunk portion 41.

The spark plug 10 is produced by, for example, the following method. First, the center electrode 36 is inserted into the axial hole 12 of the insulator 11 and disposed such that the forward end of the center electrode 36 protrudes from the insulator 11. Next, the metallic terminal 37 is fixed to the rear end of the insulator 11 with the electrical continuity between the metallic terminal 37 and the center electrode 36 maintained. Next, the forward end portion 14 of the insulator 11 is inserted from its forward end side into the heat transfer member 30. As a result, the second portion 18 and the third portion 19 expand the slit 35 to have an increased width and elastically deform the heat transfer member 30. When the heat transfer member 30 is fitted into the groove 20 of the insulator 11, the heat transfer member 30 restores its original shape, and the width of the slit 35 decreases.

Next, the insulator 11 is inserted into the metallic shell 40 with the ground electrode 48 joined thereto in advance, so that the outer circumferential surface 31 of the heat transfer member 30 is brought into contact with the inner circumferential surface 47 of the trunk portion 41. The friction between the outer circumferential surface 31 of the heat transfer member 30 and the inner circumferential surface 47 of the trunk portion 41 when the insulator 11 is inserted into the metallic shell 40 causes the heat transfer member 30 to come into contact with the forward-facing surface 23 of the groove 20. After the rear end of the metallic shell 40 is bent to attach the metallic shell 40 to the insulator 11, the ground electrode 48 is bent so as to face the center electrode 36, and the spark plug 10 is thereby obtained.

The spark plug 10 is attached to an internal combustion engine (not shown) by screwing the male thread 46 of the metallic shell 40 into a screw hole of the internal combustion engine. When the internal combustion engine is operated, the insulator 11 is heated. The heat of the insulator 11 transfers to the trunk portion 41 of the metallic shell 40 through the heat transfer member 30 fitted into the groove 20 and then transfers from the male thread 46 to the internal combustion engine.

The heat transfer member 30 is fitted into the groove 20 and thereby fixed to the insulator 11. Therefore, unlike the case where a heat transfer member is joined to the insulator 11 using a brazing material, it is unnecessary to control various parameters such as the wettability and reactivity between the brazing material and the insulator 11 and stress generated in the insulator 11 because of the difference in linear expansion coefficient between the heat transfer member and the insulator 11. Accordingly, the heat transfer member 30 can be easily fixed to the insulator 11, and the reliability of the insulator 11 with the heat transfer member 30 fixed thereto can be easily ensured.

Since at least part of the heat transfer member 30 is disposed in the groove 20, the axial position of the heat transfer member 30 relative to the insulator 11 is determined by the groove 20. This can prevent the heat rating of the spark plug 10 from changing due to, for example, vibration of the internal combustion engine to which the spark plug 10 is attached.

The heat rating of the spark plug 10 is determined by the position of the groove 20 in the direction of the axial line of the insulator 11, the size of the heat transfer member 30, its thermal conductivity, etc. It is therefore unnecessary to prepare different metallic shells 40 including trunk portions 41 having differently shaped inner circumferential surfaces 47 for different heat ratings, so that the number of metallic shells 40 stocked can be reduced.

When the male thread 46 of the metallic shell 40 is screwed into the screw hole of the internal combustion engine, the male thread 46 (the trunk portion 41) is stretched in the direction of the axial line, so that an axial force is generated. The axial position of the heat transfer member 30 relative to the metallic shell 40 is maintained only by the friction between the trunk portion 41 and the heat transfer member 30, and the heat transfer member 30 is not integrated with the trunk portion 41. Therefore, even when the trunk portion 41 is stretched in the direction of the axial line as a result of screwing of the male thread 46, the heat transfer member 30 applies almost no axial force to the insulator 11 in the direction of the axial line. Therefore, the insulator 11 is prevented from being broken, which would otherwise occurs when the male thread 46 is screwed.

The depth of the groove 20 decreases from the groove bottom 21 toward the rear opening end 22. When the axial length of the insulator 11 relative to the metallic shell 40 changes due to heat or the pressure inside a combustion chamber changes due to, for example, intake or exhaust of gas, and the wall surface of the groove 20 comes into contact with the rear end surface 33 of the heat transfer member 30, the heat transfer member 30 can apply a radially inward reaction force to the insulator 11. This allows the heat transfer member 30 and the insulator 11 to easily come into intimate contact with each other in the direction of the axial line, so that part of the heat of the insulator 11 can easily transfer to the heat transfer member 30 by heat conduction and can then transfer from the heat transfer member 30 to the metallic shell 40. Therefore, heat transfer from the insulator 11 to the metallic shell 40 can be ensured. This can prevent the occurrence of preignition.

Similarly, the depth of the groove 20 decreases from the groove bottom 21 toward the opening end 24. Therefore, when the wall surface of the groove 20 comes into contact with the forward end surface 34 of the heat transfer member 30, the heat transfer member 30 and the insulator 11 can easily come into intimate contact with each other. This allows the heat of the insulator 11 to easily transfer to the heat transfer member 30 by heat conduction.

Since the forward-facing surface 23 of the groove 20 is inclined such that its depth changes toward the rear end side as approaching the rear opening end 22 (θ1>90°), stress generated at a rear corner of the groove 20 when a bending load is applied to the first portion 17 or the second portion 18 of the insulator 11 can be relaxed. Therefore, breakage of the insulator 11 starting from the groove 20 is less likely to occur.

Similarly, since the rearward-facing surface 25 of the groove 20 is inclined such that its depth changes toward the forward end side as approaching the opening end 24 (θ2>90°), stress generated at a forward corner of the groove 20 when a bending load is applied to the first portion 17 or the second portion 18 of the insulator 11 can be relaxed. Therefore, breakage of the insulator 11 starting from the groove 20 is less likely to occur.

Since the rear end surface 33 of the heat transfer member 30 is inclined along the forward-facing surface 23, the area of contact between the forward-facing surface 23 and the heat transfer member 30 can be large. Therefore, the heat of the insulator 11 can more easily transfer to the heat transfer member 30 by heat conduction. Similarly, since the forward end surface 34 of the heat transfer member 30 is inclined along the rearward-facing surface 25, the area of contact between the rearward-facing surface 25 and the heat transfer member 30 can be large, and the heat conduction can be facilitated.

Since the heat transfer member 30 is in contact with the inner circumferential surface 47 of the metallic shell 40, heat transfer from the heat transfer member 30 to the metallic shell 40 by heat conduction can be facilitated. The heat transfer member 30 has a shape of a ring having a cutout. Therefore, when the spark plug 10 is produced, the slit 35 is widened to elastically deform the heat transfer member 30 in the radial direction of the ring such that the heat transfer member 30 can be easily fitted into the groove 20 of the insulator 11.

The outer diameter of the heat transfer member 30 when no load is applied thereto at room temperature is substantially the same as the inner diameter of the trunk portion 41 of the metallic shell 40. Therefore, when the internal combustion engine is operated and the heat transfer member 30 is thermally expanded, the outer diameter of the heat transfer member 30 increases, and the heat transfer member 30 and the trunk portion 41 come into intimate contact with each other. Therefore, heat conduction from the heat transfer member 30 to the metallic shell 40 can be facilitated. The metallic shell 40 restricts the expansion of the outer diameter of the heat transfer member 30, and the slit 35 of the heat transfer member 30 absorbs the elongation of the heat transfer member 30 due to thermal expansion.

The entire outer circumferential surface 31 of the heat transfer member 30, except for the slit 35, can come into contact with the trunk portion 41 of the metallic shell 40, so that a sufficient heat transfer area can be ensured. Therefore, heat transfer from the heat transfer member 30 to the metallic shell 40 by heat conduction can be facilitated.

When the axial length of the insulator 11 relative to the metallic shell 40 changes due to heat or the pressure inside a combustion chamber changes due to, for example, intake or exhaust of gas, and the groove 20 comes into contact with the rear end surface 33 or the forward end surface 34 of the heat transfer member 30, a radially outward force is applied to the heat transfer member 30 due to the inclination of the forward-facing surface 23 or the rearward-facing surface 25 of the groove 20. Since the heat transfer member 30 can be elastically deformed such that the width of the slit 35 increases to increase the outer diameter of the heat transfer member 30, the insulator 11 and the heat transfer member 30 can easily come into intimate contact with each other in the direction of the axial line, and the heat transfer member 30 and the metallic shell 40 can easily come into intimate contact with each other in the radial direction. This can increase the area of contact between the heat transfer member 30 and the insulator 11 and the area of contact between the heat transfer member 30 and the metallic shell 40, so that heat conduction from the insulator 11 to the metallic shell 40 can be further facilitated.

The length L1 of the heat transfer member 30 in the direction of the axial line O is larger than its length L2 in a direction orthogonal to the axial line O, so that the depth of the groove 20 into which the heat transfer member 30 is fitted can be reduced. Therefore, the radial thickness of a portion of the insulator 11 in which the groove 20 is formed can be ensured, and the mechanical strength and dielectric strength of the insulator 11 can be ensured.

In the heat transfer member 30, the axial length of the inner circumferential surface 32 disposed along the groove bottom 21 is larger than the length L2, so that the area of the heat transfer member 30 that contributes to heat transfer from the groove bottom 21 can be increased. Therefore, heat transfer from the insulator 11 to the heat transfer member 30 can be facilitated through heat transmission (convection) and heat conduction from the groove bottom 21 of the insulator 11 to the inner circumferential surface 32 of the heat transfer member 30.

When the heat transfer member 30 satisfies the relation of L1>L2, the depth of the groove 20 can be reduced, and the difference between the outer diameter of the third portion 19 in which the groove 20 is formed and the inner diameter of the heat transfer member 30 can be reduced. This allows not only the rear opening end 22 of the groove 20 to be brought close to the inner circumferential surface 47 of the metallic shell 40 but also the forward opening end 24 through which the heat transfer member 30 passes when it is fitted into the groove 20 to be brought close to the inner circumferential surface 47 of the metallic shell 40. Therefore, not only the heat conduction from the heat transfer member 30 to the metallic shell 40 but also the heat transmission (convection) from the third portion 19 to the metallic shell 40 are facilitated, so that the heat transfer from the insulator 11 to the metallic shell 40 can be further facilitated.

At least at room temperature, the heat transfer member 30 is spaced apart from the forward-facing surface 23 or the rearward-facing surface 25 of the groove 20. Therefore, even when the heat transfer member 30 expands in the direction of the axial line due to the difference in linear expansion coefficient between the heat transfer member 30 and the insulator 11, the axial stress generated in the insulator 11 can be reduced. Therefore, breakage of the insulator 11 due to the difference in linear expansion between the heat transfer member 30 and the insulator 11 can be prevented.

At least at room temperature, the inner circumferential surface 32 of the heat transfer member 30 is slightly spaced apart from the groove bottom 21. Therefore, even when the diameter of the groove bottom 21 increases due to thermal expansion of the insulator 11, radial stress generated in the insulator 11 can be reduced, so that breakage of the insulator 11 can be prevented.

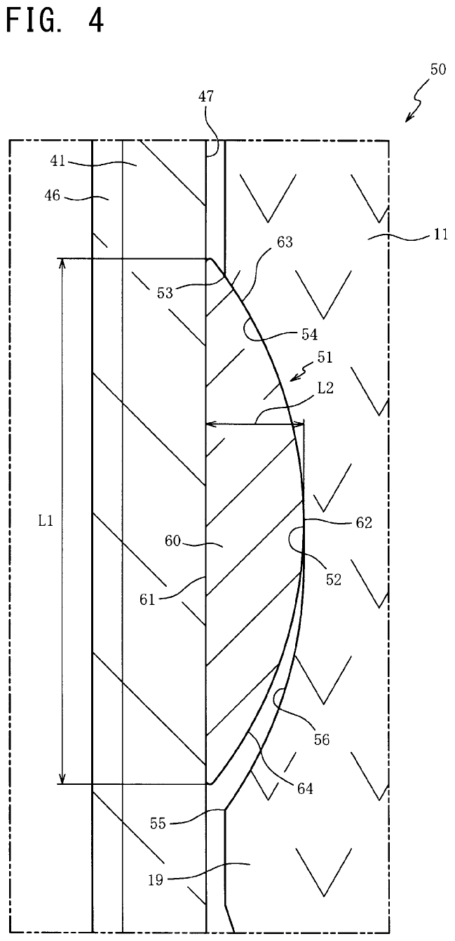

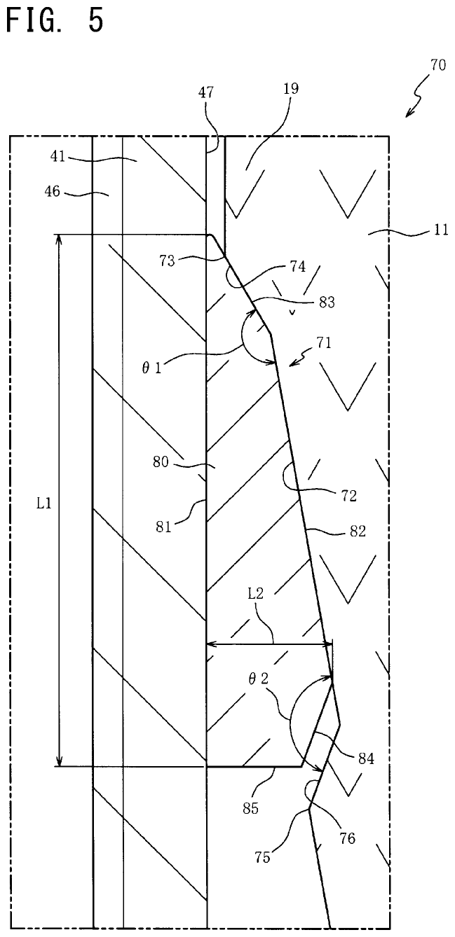

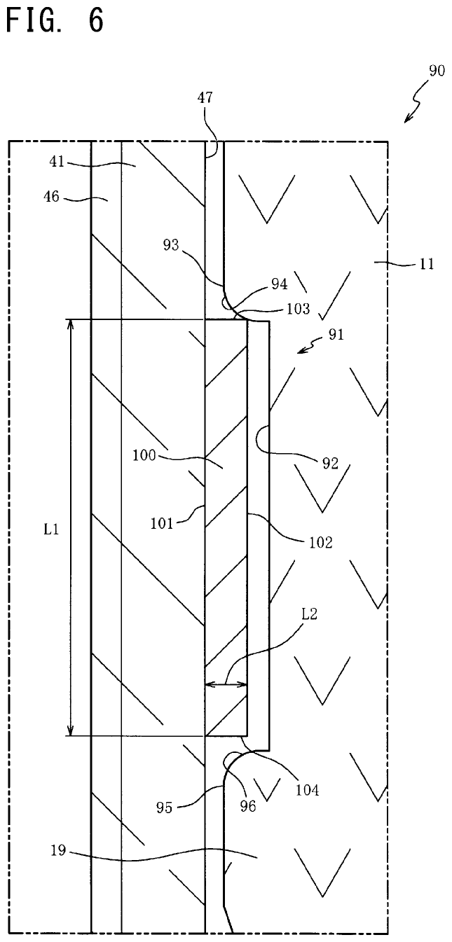

Referring to FIG. 4, a second embodiment will be described. In the first embodiment described above, the forward-facing surface 23 and the rearward-facing surface 25 of the groove 20 are inclined straight with respect to the axial line O in the cross section containing the axial line O. However, in the second embodiment, a description will be given of the case where a forward-facing surface 54 and a rearward-facing surface 56 of a groove 51 are curved concavely in a cross section including the axial line O (see FIG. 1). The same parts as those in the first embodiment are denoted by the same numerals, and their description will be omitted. FIG. 4 is a partial enlarged view of a spark plug 50 in the second embodiment. FIG. 4 is a partial enlarged view of the portion indicated by III in FIG. 1, as is FIG. 3 (the same applies to FIGS. 5 and 6).

In the cross section of the spark plug 50 that includes the axial line O, the depth of the groove 51 decreases gradually from a groove bottom 52 toward a rear opening end 53 and decreases gradually from the groove bottom 52 toward a forward opening end 55. The forward-facing surface 54 located adjacent to the rear end of the groove bottom 52 has a concave surface curved such that its depth changes toward the rear end side as approaching the rear opening end 53. The rearward-facing surface 56 located adjacent to the forward end of the groove bottom 52 has a concave surface curved such that its depth changes toward the forward end side as approaching the opening end 55.

A heat transfer member 60 is a metallic cylindrical member having a slit 35 (see FIG. 2) which is formed by partially cutting the ring-shaped member. A rear end surface 63 of the heat transfer member 60 has a convexly curved surface inclined along the forward-facing surface 54 of the groove 51. A forward end surface 64 of the heat transfer member 60 has a convexly curved surface inclined along the rearward-facing surface 56 of the groove 51.

The axial length of the heat transfer member 60 is set such that, when the rear end surface 63 of the heat transfer member 60 comes into contact with the forward-facing surface 54 of the groove 51, a gap is formed between the forward end surface 64 of the heat transfer member 60 and the rearward-facing surface 56 of the groove 51. Similarly, when the forward end surface 64 of the heat transfer member 60 comes into contact with the rearward-facing surface 56 of the groove 51, a gap is formed between the rear end surface 63 of the heat transfer member 60 and the forward-facing surface 54 of the groove 51. The axial length L1 of the heat transfer member 60 (in the present embodiment, the length of an outer circumferential surface 61) is larger than its length L2 in a direction orthogonal to the axial line O (see FIG. 1). In the present embodiment, the outer circumferential surface 61 of the heat transfer member 60 is in contact with the inner circumferential surface 47 of the trunk portion 41.

In the second embodiment, since the groove 51 has a curved shape extending from the rear opening end 53 through the groove bottom 52 to the opening end 55 in the cross section including the axial line O, stress generated in the groove 51 when a bending load is applied to the first portion 17 or the second portion 18 of the insulator 11 can be reduced. Therefore, breakage of the insulator 11 starting from the groove 51 is less likely to occur.

Since the shape of the heat transfer member 60 is set such that an inner circumferential surface 62 of the heat transfer member 60 and its rear end surface 63 can come into contact with the groove bottom 52 and the forward-facing surface 54, respectively, of the groove 51, the area of contact between the insulator 11 and the heat transfer member 60 that contributes to heat conduction can be ensured. Therefore, heat transfer from the insulator 11 to the heat transfer member 60 can be facilitated.

Referring to FIG. 5, a third embodiment will be described. In the first embodiment described above, the groove bottom 21 is parallel to the axial line O in the cross section including the axial line O. However, in the third embodiment, a description will be given of the case where a groove bottom 72 is inclined with respect to the axial line O in a cross section including the axial line O (see FIG. 1). The same parts as those in the first embodiment are denoted by the same numerals, and their description will be omitted. FIG. 5 is a partial enlarged view of a spark plug 70 in the third embodiment.

In the cross section of the spark plug 70 that includes the axial line O, a groove 71 has a groove bottom 72 inclined so as to approach the axial line O as the distance to its forward end decreases. The depth of the groove 71 decreases gradually from the rear end of the groove bottom 72 toward the rear opening end 73 and decreases gradually from the forward end of the groove bottom 72 toward a forward opening end 75. The forward opening end 75 of the groove 71 is located radially inward of the rear opening end 73.

A forward-facing surface 74 located adjacent to the rear end of the groove bottom 72 is a conical surface inclined such that its depth changes toward the rear end side as approaching the rear opening end 73. A rearward-facing surface 76 located adjacent to the forward end of the groove bottom 72 is a conical surface inclined such that its depth changes toward the forward end side as approaching the opening end 75. In the cross section including the axial line O, the angle θ1 between the groove bottom 72 and the forward-facing surface 74 satisfies 90°<θ1<180°, and the angle θ2 between the groove bottom 72 and the rearward-facing surface 76 satisfies 90°<θ2<180°.

A heat transfer member 80 is a metallic cylindrical member having a slit 35 (see FIG. 2) which is formed by partially cutting the ring-shaped member. In the heat transfer member 80, the axial length of an inner circumferential surface 82 of the heat transfer member 80 is shorter than the axial length of the groove bottom 72. A rear end surface 83 of the heat transfer member 80 is a conical surface inclined along the forward-facing surface 74 of the groove 71. A forward end surface 84 of the heat transfer member 80 is a conical surface inclined along the rearward-facing surface 76 of the groove 71. A connection surface 85 is an annular surface connecting an outer circumferential surface 81 of the heat transfer member 80 to its forward end surface 84.

The maximum axial length L1 of the heat transfer member 80 (in the present embodiment, the length of the outer circumferential surface 81) is longer than the maximum length L2 in a direction orthogonal to the axial line O (see FIG. 1). In the present embodiment, the outer circumferential surface 81 of the heat transfer member 80 is in contact with the inner circumferential surface 47 of the trunk portion 41. A gap is present between the third portion 19 of the insulator 11 and the inner circumferential surface 47 of the trunk portion 41.

In the third embodiment, since the forward opening end 75 of the groove 71 is located radially inward of the rear opening end 73, the distance between the inner circumferential surface 47 of the trunk portion 41 and a portion of the insulator 11 that is located forward of the groove 71 can be increased. This can prevent a reduction in insulation resistance, which reduction would otherwise occur when carbon contained in combustion gas entering the gap between the inner circumferential surface 47 of the trunk portion 41 and the forward end portion 14 of the insulator 11 adheres to the surface of the forward end portion 14. Therefore, contamination resistance can be improved.

Referring to FIG. 6, a fourth embodiment will be described. In the second embodiment described above, the forward-facing surface 54 and the rearward-facing surface 56 of the groove 51 are concavely curved in the cross section including the axial line O. In the fourth embodiment, a description will be given of the case where a forward-facing surface 94 and a rearward-facing surface 96 of a groove 91 are convexly curved in a cross section including the axial line O. The same parts as those in the first embodiment are denoted by the same numerals, and their description will be omitted. FIG. 6 is a partial enlarged view of a spark plug 90 in the fourth embodiment.

In a cross section of the spark plug 90 that includes the axial line O, the depth of the groove 91 decreases gradually from the rear end of a groove bottom 92 toward a rear opening end 93 and decreases gradually from the forward end of the groove bottom 92 toward a forward opening end 95. The forward-facing surface 94 adjacent to the rear end of the groove bottom 92 has a curved surface that is radially outwardly convex, and the rearward-facing surface 96 adjacent to the forward end of the groove bottom 92 has a curved surface that is radially outwardly convex.

A heat transfer member 100 is a metallic cylindrical member having a slit 35 (see FIG. 2) which is formed by partially cutting the ring-shaped member. In a cross section including the axial line O, a rear end surface 103 and a forward end surface 104 of the heat transfer member 100 are flat surfaces perpendicular to the axial line O. The axial length L1 of the heat transfer member 100 is longer than its length L2 in a direction orthogonal to the axial line O (see FIG. 1). The length L1 of the heat transfer member 100 is shorter than the axial length of the groove bottom 92.

In the present embodiment, an outer circumferential surface 101 of the heat transfer member 100 is in contact with the inner circumferential surface 47 of the trunk portion 41. At room temperature, the inner diameter of the heat transfer member 100 is larger than the diameter of the groove bottom 92, and therefore a gap is formed between an inner circumferential surface 102 of the heat transfer member 100 and the groove bottom 92. When the rear end surface 103 of the heat transfer member 100 comes into contact with the forward-facing surface 94, a gap is formed between the forward end surface 104 of the heat transfer member 100 and the rearward-facing surface 96. Similarly, when the forward end surface 104 of the heat transfer member 100 comes into contact with the rearward-facing surface 96, a gap is formed between the rear end surface 103 and the forward-facing surface 94.

In the fourth embodiment, the depth of the groove 91 decreases from the groove bottom 92 toward the opening ends 93 and 95. Therefore, when the axial length of the insulator 11 relative to the metallic shell 40 changes due to heat or the pressure inside a combustion chamber changes due to, for example, intake or exhaust of gas, and the rear end surface 103 or the forward end surface 104 of the heat transfer member 100 comes into contact with a curved portion of the forward-facing surface 94 or the rearward-facing surface 96, which curved portion is inclined with respect to the axial line O, the heat transfer member 100 can apply a radially inward reaction force to the insulator 11. This allows the heat transfer member 100 and the insulator 11 to easily come into intimate contact with each other in the direction of the axial line, as in the first to third embodiments. Therefore, heat transfer from the insulator 11 to the metallic shell 40 can be ensured, and the occurrence of preignition can be prevented.

The present invention has been described based on the embodiments. However, the present invention is not limited to these embodiments. It is readily understood that various improvements and changes and modifications can be made without departing from the scope of the present invention.

In the embodiments, stainless steel is exemplified as the material of the heat transfer member 30, 60, 80, 100, but this is not a necessary limitation. It is of course possible to use other metal materials such as chromium, ceramics such as silicon carbide, TiB₂, and ZrB₂, and carbon that are excellent in oxidation resistance and thermal conductivity. Moreover, it is of course possible to use a member prepared by coating the surface of a base material such as a metal with, for example, carbon or ceramic as the heat transfer member 30, 60, 80, 100.

In the embodiments described above, the linear slit 35 extending along the axial line O is formed in the heat transfer member 30, 60, 80, 100, but this is not a necessary limitation. It is of course possible that the slit 35 is formed so as to be skewed relative to the axial line O or formed into a curved shape. The slit 35 of the heat transfer member 30, 60, 80, 100 is not always necessary. When an annular heat transfer member with no slit is used, the heat transfer member is, for example, heated to increase the inner diameter of heat transfer member, and then the heated transfer member is attached to the insulator 11.

In the embodiments described above, the seal member 49 is used to ensure gastightness between the insulator 11 and the metallic shell 40, but this is not a necessary limitation. It is of course possible that, to ensure gastightness, a packing is disposed between the forward end surface of the protruding portion 15 of the insulator 11 and the inner circumferential surface of the seat portion 42 of the metallic shell 40. The packing is an annular plate member formed of a metal material such as a mild steel sheet softer than the metal material forming the metallic shell 40. By disposing the packing, the seal member 49 can be omitted.

In the first embodiment described above, the inner circumferential surface 32 of the heat transfer member 30 and the groove bottom 21 are spaced apart from each other at least at room temperature, but this is not a necessary limitation. It is of course possible that the dimensions of the inner circumferential surface 32 of the heat transfer member 30 and the groove bottom 21 are set such that they are in contact with each other. By bringing the inner circumferential surface 32 of the heat transfer member 30 and the groove bottom 21 into contact with each other, heat transfer from the insulator 11 to the heat transfer member 30 by heat conduction can be facilitated.

In the third embodiment described above, the inner circumferential surface 47 of the metallic shell 40 is parallel to the axial line O in the cross section including the axial line O, but this is not a necessary limitation. It is of course possible that the inner diameter of the trunk portion 41 of the metallic shell 40 can be reduced toward the forward end side so as to conform to the groove bottom 72 having a tapered shape. In this case, the wall thickness of the heat transfer member 80 is set according to the trunk portion 41 of the metallic shell 40 that has an inner diameter decreasing toward the forward end side. The distance between the insulator 11 and the trunk portion 41 of the metallic shell 40 is thereby reduced, so that heat transfer from the insulator 11 to the metallic shell 40 by heat transmission (convection) can be facilitated.

In the fourth embodiment described above, the heat transfer member 100 has a corner at which the rear end surface 103 of the heat transfer member 100 intersects the inner circumferential surface 102 thereof and a corner at which the forward end surface 104 intersects the inner circumferential surface 102, but this is not a necessary limitation. It is of course possible that these edges are rounded or chamfered. When the corners are rounded or chamfered to form rounded or chamfered corner surfaces, the area of contact between the heat transfer member 100 (the rounded or chamfered corner surfaces) and the insulator 11 can be increased, and damage to the forward-facing surface 94 and the rearward-facing surface 96 when the heat transfer member 100 comes into contact with the insulator 11 can be reduced.

In the embodiments described above, the depth of the groove 20, 51, 71, 91 decreases toward the rear opening end 22, 53, 73, or 93 and decreases toward the forward opening end 24, 55, 75, 95, but this is not a necessary limitation. It is of course sufficient that the depth of the groove 20, 51, 71, 91 decreases toward at least one of the rear opening end 22, 53, 73, 93 and the forward opening end 24, 55, 75, 95. This is because the heat transfer member 30, 60, 80, 100 and the insulator 11 can easily come into intimate contact with each other in a region in which the groove 20, 51, 71, 91 has a reduced depth.

### REFERENCE SIGNS LIST

10, 50, 70, 90 spark plug
11 insulator
20, 51, 71, 91 groove
22, 53, 73, 93 rear opening end
24, 55, 75, 95 forward opening end
23, 54, 74, 94 forward-facing surface
25, 56, 76, 96 rearward-facing surface
30, 60, 80, 100 heat transfer member
33, 63, 83, 103 rear end surface
34, 64, 84, 104 forward end surface
40 metallic shell
47 inner circumferential surface
46 male thread
L1, L2 length
O axial line

1. A spark plug comprising:
a tubular insulator extending in a direction of an axial line from a forward end side to a rear end side; and
a tubular metallic shell fixed to an outer circumference of the insulator, the tubular metallic shell having a male thread formed on a part of an outer circumferential surface thereof,
wherein the insulator has a groove formed in a region of the outer circumference of the insulator, the region overlapping the male thread of the metallic shell in the direction of the axial line,
at least a part of a heat transfer member is disposed in the groove, and
in a cross section passing through the axial line and extending along the axial line, the depth of the groove decreases toward at least one of a forward opening end of the groove and a rear opening end thereof.

2. The spark plug according to claim 1, wherein a forward-facing surface of the groove of the insulator is inclined such that the depth of the forward-facing surface changes toward the rear end side as approaching the opening end of the groove at the rear end side, or a rearward-facing surface of the groove of the insulator is inclined such that the depth of the rearward-facing surface changes toward the forward end side as approaching the opening end of the groove at the forward end side.

3. The spark plug according to claim 2, wherein a rear end surface of the heat transfer member is inclined along the forward-facing surface, or a forward end surface of the heat transfer member is inclined along the rearward-facing surface.

4. The spark plug according to claim 1, wherein the heat transfer member is in contact with part of an inner circumferential surface of the metallic shell.

5. The spark plug according to claim 1, wherein the heat transfer member has a ring shape having a cutout.

6. The spark plug according to claim 1, wherein a length of the heat transfer member in the direction of the axial line is longer than a length of the heat transfer member in a direction orthogonal to the axial line.
